(19) United States
(12) Patent Application Publication
(10) Pub. No.: US 2002/0036902 A1
(43) Pub. Date: Mar. 28, 2002

(54) Portable lighting devices having a fabric housing portion

(76) Inventors: Peter F. Lynch, Skaneateles, NY (US); Scott W. Osiecki, Skaneateles, NY (US); Steven D. Sieckowski, Camillus, NY (US)

Correspondence Address: ROBERT W WELSH, EVEREADY BATTERY COMPANY INC, 25225 DETROIT ROAD, P O BOX 450777, WESTLAKE, OH, 44145

(21) Appl. No.: 09/907,174

(22) Filed: Jul. 17, 2001

Related U.S. Application Data
(60) Provisional application No. 60/260,809, filed on Jan. 10, 2001.
(60) Provisional application No. 60/234,868, filed on Sep. 22, 2000.

(51) Int. Cl. F21V 1/00

(52) U.S. Cl. 362/166

(57) ABSTRACT

The inventive portable lighting device has a substantial portion thereof constructed of one or more fabric materials. The use of a fabric housing allows for additional functionality through the use of flexible storage space integrated into the devices, thereby yielding unique functionality and aesthetics. Various sized lighting devices can be designed by combining soft and hard materials (i.e., plastic, metal, fabric, rubber, foam, etc.) that allow for the addition of other objects to be securely and comfortably attached to, or carried in, the lighting device. The use of fabric also provides unique access to the batteries and bulb of the flashlight. The result of using fabric in a lighting device provides for a product family constructed of various materials that allow for flexible yet integrated looking and feeling storage solutions.

### CROSS-REFERENCE TO RELATED APPLICATIONS

This application claims priority under 35 U.S.C. §119(e) on U.S. Provisional Patent Application No. 60/260,809, entitled “PORTABLE LIGHTING DEVICE HAVING A FABRIC HOUSING,” filed Jan. 10, 2001, by Peter F. Lynch et al., and on U.S. Provisional Patent Application No. 60/234,868, entitled “PORTABLE LIGHTING DEVICE HAVING A FABRIC HOUSING,” filed Sep. 22, 2000, by Peter F. Lynch et al., the entire disclosures of which are incorporated herein by reference.

### BACKGROUND OF THE INVENTION

The present invention generally relates to portable lighting devices such as flashlights and lanterns.

Conventional flashlights and lanterns are typically constructed of plastic, rubber, and/or metal. Because of limitations as to the flexibility, coloration, and texture of these materials, the design of flashlights and lanterns is limited. Additionally, to the extent that such lighting devices incorporate storage locations for additional light bulbs or batteries, or to the extent they allow access to the batteries used to power the device, the flashlights must be designed with mechanical parts that interact by pivoting, unscrewing, or unlatching. Such constructions can eventually wear out and often add to the price of manufacturing the flashlight.

U.S. Pat. Nos. 5,188,450, 5,921,657, 5,947,585, Des. 338,338, Des. 374,769, and Des. 381,805 disclose various flashlight accessories including fabric holders having pouches into which a flashlight and spare batteries may be inserted and stored. Such accessories are not part of the flashlight itself, and the fabric is not fastened to the flashlight casing in any way.

U.S. Pat. No. 5,463,539 discloses a small portable light having a housing that is in the form of a fabric pouch. The battery and switch mechanism is entirely contained within the fabric pouch and a small hole is provided in the pouch in which a lens is secured to project light outwardly from an LED located within the fabric pouch. The fabric pouch is made of a single fabric material. The fabric pouch does not include any supplemental storage compartment for receiving spare batteries or other personal items.

### SUMMARY OF THE INVENTION

It is therefore an aspect of the present invention to provide portable lighting devices having a substantial portion thereof constructed of materials other than plastic or metal and thereby avoid some of the design limitations imposed by the use of these materials.

The portable lighting devices of the present invention have at least a portion of the device housing made of fabric. Such fabric may include nylon, leather, canvas, Kevlar®, Tyvek®, Gore-Tex®, and other fabric materials.

As will be explained further below and as will become apparent from a review of the many embodiments of this invention, the use of a fabric housing allows for additional functionality through the use of flexible storage space integrated into the devices, thereby yielding unique functionality and aesthetics. Various sized lighting devices can be designed by combining soft and hard materials (i.e., plastic, metal, fabric, rubber, foam, etc.) that allow for the addition of other objects to be securely and comfortably attached to, or carried in, the lighting device. The use of fabric also provides unique access to the batteries and bulb of the flashlight. The result of using fabric in a lighting device provides for a product family constructed of various materials that allow for flexible yet integrated looking and feeling storage solutions.

According to one aspect of the invention, a portable lighting device is provided that comprises: a rigid frame at least partially defining a battery compartment having battery contact terminals; a reflector mounted to the frame; a light source mounted to the frame forward of the reflector, the light source being selectively electrically coupled to the battery contact terminals via a switching mechanism; and a fabric portion fastened to the frame and made of a fabric material, the fabric portion including a storage compartment that is accessible from the exterior of the lighting device.

According to another aspect of the invention, a portable lighting device is provided that comprises: a rigid frame at least partially defining a battery compartment having battery contact terminals; a light source mounted to the frame, the light source being selectively electrically coupled to the battery contact terminals via a switching mechanism; and a fabric portion covering a portion of the frame and made of at least two different fabric materials.

According to yet another aspect of the invention, a portable lighting device is provided that comprises: a rigid casing including a recess for receiving a switching mechanism and one of a bezel and lens ring; a light source supported on the casing and selectively activated in response to actuation of the switching mechanism; and a fabric component fastened to and partially covering said casing, wherein an uncovered portion of the casing includes at least one of the bezel, the lens ring, and the recess for receiving the switching mechanism.

According to yet another aspect of the invention, a portable lighting device is provided that comprises: a rigid frame at least partially defining a battery compartment having battery contact terminals; a light source mounted to the frame, the light source being selectively electrically coupled to the battery contact terminals via a switching mechanism; and a fabric portion covering a portion of the frame and including at least one storage compartment that is accessible from the exterior of the lighting device, the fabric portion including a plurality of storage pockets within the storage compartment.

According to still another aspect of the present invention, a lantern is provided that comprises: a rigid casing having a rearward end and a bezel provided at a forward end, the casing defining a battery compartment having battery contact terminals, the bezel defining a light emitting opening; a lens disposed across the light emitting opening of the bezel; a switching mechanism mounted on the casing and electrically coupled to at least one of the battery contact terminals; a reflector mounted to the casing within the bezel; a light source supported by the casing and electrically coupled to the switching mechanism, the light source disposed slightly forward of a rearwardmost portion of the reflector such that light emitted from the light source is reflected from the reflector through the lens; a fabric saddle bag covering a portion of the casing leaving portions of the casing uncovered and exposed to an exterior of the lantern, such uncovered portions including the bezel and the switching mechanism, the fabric saddle bag including a plurality of storage compartments, a plurality of closing mechanisms for closing the storage compartments that are accessible from the exterior of the lantern, and a plurality of pockets within at least one of the storage compartments, wherein the fabric saddle bag is made of at least two different fabric materials; and a fastening mechanism for fastening the fabric saddle directly to the casing, the fastening mechanism including a first part fixed to the casing and a second part fixed to the fabric saddle.

According to another aspect of the invention, a portable lighting device is provided that comprises: a casing having a rearward end and a forward end; a flexible strap having first and second ends, the first end fastened at the rearward end of the casing, the strap having a fastener provided at the second end; a lens ring provided at the forward end of the casing and including at least one aperture configured to receive the fastener; and a light source positioned at the forward end of the casing.

These and other features, advantages, and objects of the present invention will be further understood and appreciated by those skilled in the art by reference to the following specification, claims, and appended drawings.

### BRIEF DESCRIPTION OF THE DRAWINGS

In the drawings:

FIG. 1 is a perspective view showing the front, top, and a first side of a lantern constructed in accordance with a first embodiment of the present invention;

FIG. 2 is an elevational view of the first side of the lantern of FIG. 1 in a horizontal first position;

FIG. 3 is an elevational view of the front of the lantern of FIGS. 1 and 2;

FIG. 4 is an elevational view of the rear of the lantern of FIGS. 1-3;

FIG. 5 is a plan view of the top of the lantern of FIGS. 1-4;

FIG. 6 is a plan view of the bottom of the lantern of FIGS. 1-5;

FIG. 7 is an elevational view of the first side of the lantern of FIGS. 1-6;

FIG. 8 is a close-up elevational view of a portion of the lantern of FIGS. 1-7;

FIGS. 9A and 9B are perspective views of a lantern constructed in accordance with a second embodiment of the present invention;

FIG. 9C is an exploded perspective view of the lantern shown in FIGS. 9A and 9B;

FIGS. 10A and 10B are perspective views of a lantern constructed in accordance with a third embodiment of the present invention;

FIG. 11 is a perspective view of a flashlight constructed in accordance with a fourth embodiment of the present invention;

FIG. 12 is a perspective view of a flashlight constructed in accordance with a fifth embodiment of the present invention;

FIG. 13 is a perspective view of a flashlight constructed in accordance with a sixth embodiment of the present invention;

FIG. 14 is a perspective view of a lantern constructed in accordance with a seventh embodiment of the present invention;

FIG. 15 is a perspective view of a lantern constructed in accordance with an eighth embodiment of the present invention;

FIG. 16 is a perspective view of flashlight constructed in accordance with a ninth embodiment of the present invention;

FIG. 17 is a perspective view of a lantern constructed in accordance with a tenth embodiment of the present invention;

FIG. 18 is a perspective view of a lantern constructed in accordance with an eleventh embodiment of the present invention;

FIG. 19A is a perspective view of a flashlight constructed in accordance with a twelfth embodiment of the present invention;

FIG. 19B is a perspective view of the flashlight shown in FIG. 19A shown with a storage compartment in an open position;

FIG. 20A is a perspective view of a flashlight constructed in accordance with a thirteenth embodiment of the present invention;

FIG. 20B is a perspective view of the flashlight shown in FIG. 20A shown with a storage compartment in an open position;

FIG. 21A is a perspective view of a flashlight constructed in accordance with a fourteenth embodiment of the present invention; and

FIG. 21B is a perspective view of the flashlight shown in FIG. 21A shown with a storage compartment in an open position.

### DETAILED DESCRIPTION OF THE PREFERRED EMBODIMENTS

Reference will now be made in detail to the present preferred embodiments of the invention, examples of which are illustrated in the accompanying drawings. Wherever possible, the same reference numerals will be used throughout the drawings to refer to the same or like parts.

For purposes of description herein, the terms “upper,” “lower,” “right,” “left,” “rear,” “front,” “vertical,” “horizontal,” “top,” “bottom,” and derivatives thereof shall relate to the invention as viewed by a person holding the flashlight/lantern in a generally horizontal position with the light beam emitted from the front of the flashlight/lantern in a forward direction. However, it is to be understood that the invention may assume various alternative orientations, except where expressly specified to the contrary. It is also to be understood that the specific device illustrated in the attached drawings and described in the following specification is simply an exemplary embodiment of the inventive concepts defined in the appended claims. Hence, specific dimensions, proportions, and other physical characteristics relating to the embodiment disclosed herein are not to be considered as limiting, unless the claims expressly state otherwise.

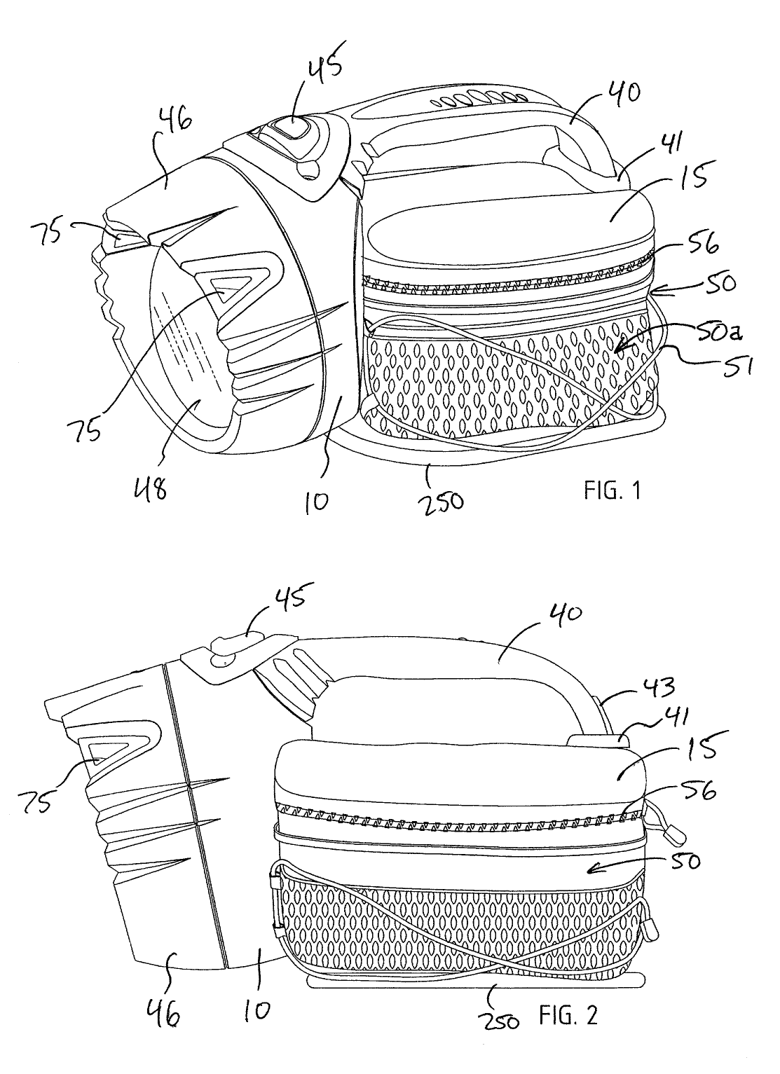

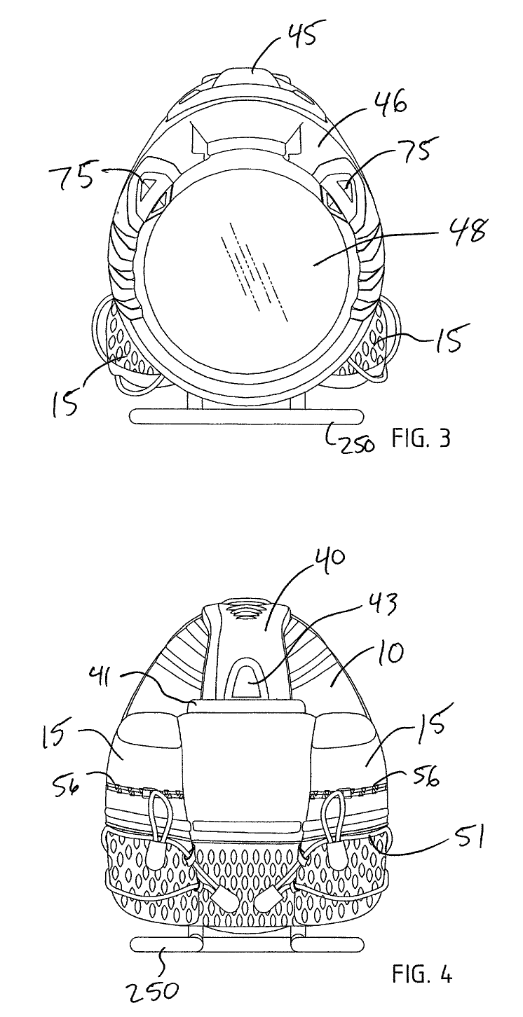

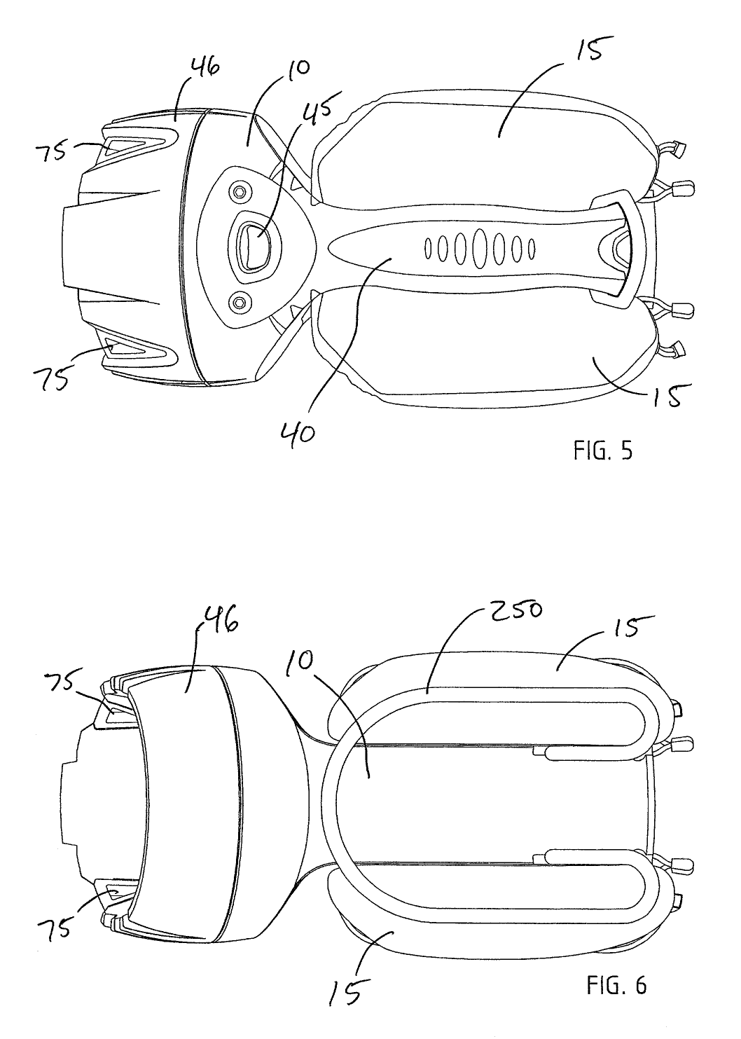

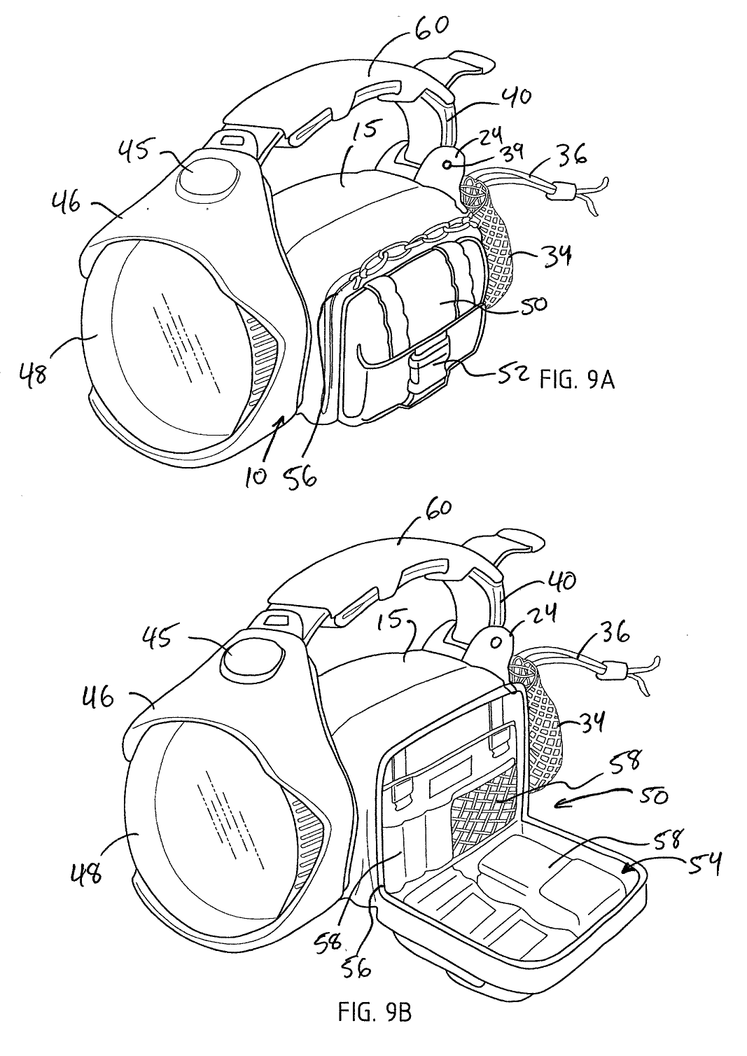

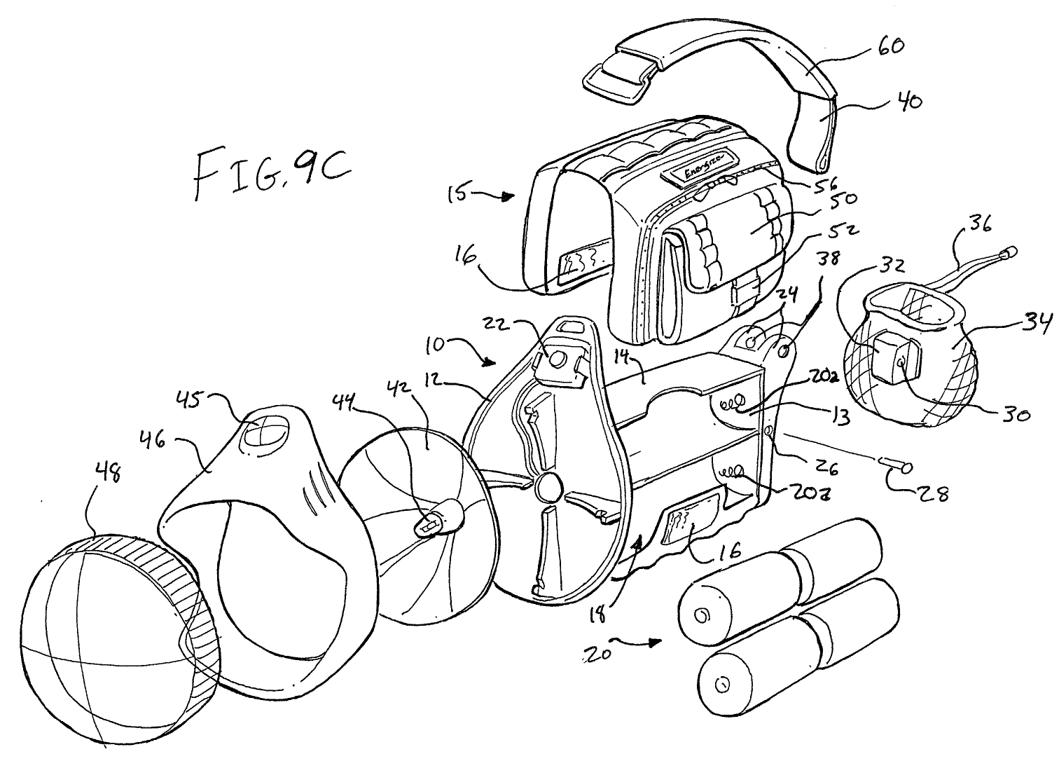

As will be described in further detail below, the portable lighting device of the present invention preferably comprises a rigid frame/casing 10 that at least partially defines a battery compartment 18 having battery contact terminals 20a (see FIG. 9C). The portable lighting device also includes a reflector 42 mounted to frame 10 and a light source 44 mounted to frame 10 forward of reflector 42. Light source 44 is selectively electrically coupled to battery contact terminals 20a via a switching mechanism 22. The portable lighting device also includes a fabric portion/component 15 that is preferably fastened to frame 10 and made of a fabric material. As will be apparent from the description below of the several embodiments, fabric portion 15 may take several different forms. For example, fabric portion 15 may be configured as a saddle bag that wraps partially around frame 10 (See FIGS. 1-9C).

Preferably, fabric portion 15 includes at least one storage compartment 50 (FIGS. 9A and 9C) that is accessible from the exterior of the lighting device. The fabric portion 15 of the portable lighting device may include a plurality of storage pockets 58 within storage compartment(s) 50. The portable lighting device may further include one or more closing mechanisms for closing each storage compartment 50. The closing mechanisms may include any one or a combination of a zipper 56 (FIG. 9B), a hook and loop type fastener (not shown), a drawstring 36 (FIG. 9A), and a clip 52 (FIGS. 9A and 12). On the portable lighting device, a closing mechanism for at least one of the storage compartments may be a different type from a closing mechanism for another one of the storage compartments.

Fabric portion 15 may be made of any one or a combination of nylon, canvas, leather, Kevlar®, Tyvek®, and Gore-Tex®, or any other suitable fabric. As will be apparent from the description of the embodiments below, any one lighting device may include a fabric portion that includes two or more different types of fabric materials that may be exposed on an exterior of the lighting device.

Fabric portion 15 may be releasably fastened to frame 10, and is preferably fastened to frame 10 by a fastening mechanism 16, which may have a first part fixed to frame 10 and a second part fixed to fabric portion 15. Fastening mechanism 16 may be a hook and loop-type fastener, a strap, one or more snap connectors, etc. Alternatively, fabric portion 15 may be adhesively fastened to frame 10 or fastened to frame 10 by a thermal bond.

The portable lighting device further includes a lens ring/bezel 46 that may be rotatably attached to frame 10 by means of threads (not shown). Frame 10 may include a recess for receiving switching mechanism 22 and its cover 45 unless switching mechanism 22 is integrated into lens ring 46 so as to be activated and deactivated through rotation of lens ring 46. When switching mechanism 22 is provided in a recess in frame 10, fabric portion 15 preferably only covers a portion of frame 10 leaving an uncovered portion that exposes switching mechanism 22 (see, for example, FIGS. 1, 2, 5, and 9A). Switch mechanism 22 may be a pushbutton switch, a slide switch, a rotary switch, or any other suitable switch structure.

The portable lighting device of the present invention may further include a handle 40 attached to frame 10. Handle 40 may be a rigid extension of frame 10, a rigid structure releasably attached at one or both ends to frame 10, or may be a flexible material attached to one or both of frame 10 and fabric portion 15. The portable lighting device may include two or more separate fabric portions/components, such as a saddle bag 15 and a fabric pouch 34 (see FIGS. 9A and 9C). In addition to leaving any switching mechanism 22 uncovered, fabric portion 15 may also leave an uncovered portion of frame 10 that includes lens ring/bezel 46.

As shown in FIG. 9C, frame 10 may only partially define a battery compartment 18 and fabric portion 15 may define a remaining portion of the battery compartment such that partial removal of fabric portion 15 provides access to the battery compartment.

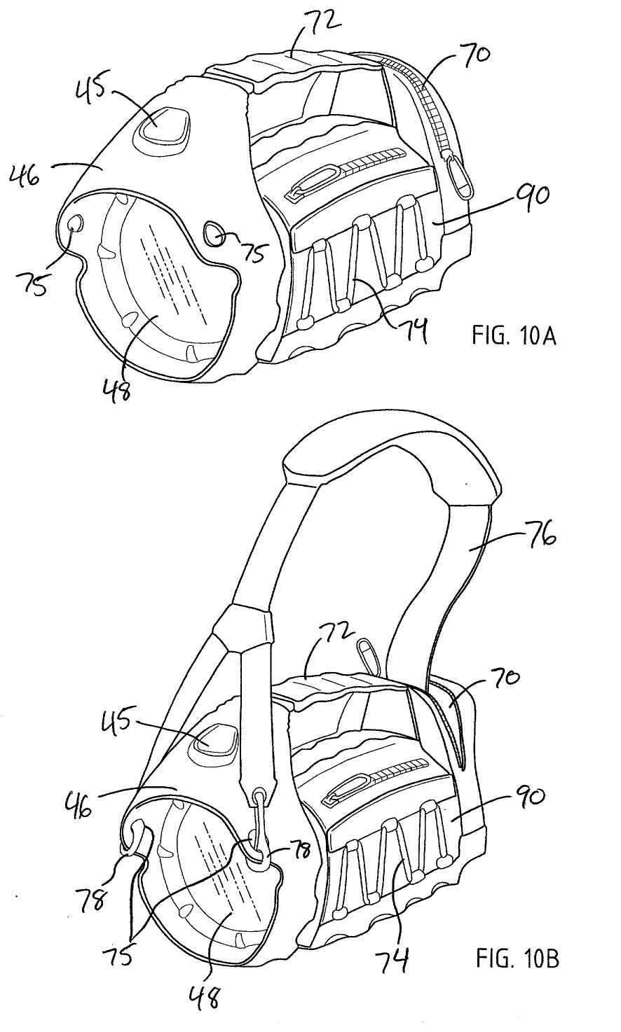

As shown in FIG. 10B, the portable lighting device of the present invention may include a flexible strap 76 having first and second ends, with the first end fastened at a rearward end of frame/casing 10. Strap 76 may have a fastener, such as a spring clip 78, provided at the second end. The lens ring 46 may include at least one aperture 75 configured to receive fastener 78. Strap 76 may have an adjustable length and thereby be adjustable to a first length suitable for use as a handle and a second length suitable for use as a shoulder strap.

FIGS. 1-8 illustrate a lantern constructed in accordance with a first embodiment of the present invention. As shown, the lantern includes a casing/frame 10 in which is defined a battery compartment (not shown). The battery compartment is accessed by removal of lens ring 46, which is threaded onto threads of casing 10. In addition to supporting a lens 48, lens ring 46 further supports a reflector and light source (not shown). Provided on casing 10 is a recess in which a switching mechanism is mounted. The switching mechanism includes a switch cover 45 for selectively electrically coupling the light source to batteries contained within the battery compartment.

The lantern further includes a fabric portion 15, which, in this embodiment, is in the form of a saddle bag. Saddle bag 15 includes a plurality of storage compartments 50, some of which may be closed by a closing mechanism such as a zipper 56. Additional storage compartments 50a are provided without any form of closure mechanism, such as the mesh pocket 50a provided about the outside of saddle bag 15. A shock cord 51 or other material may be provided for functional and/or aesthetic appearances.

Although not shown in this embodiment, saddle bag 15 is fastened to casing 10 by means of several pairs of hook-and-loop type fasteners. Additionally, a hole is provided in saddle bag 15 proximate one end of a handle 40. The other end of handle 40 is either connected to, or an integral extension of, an uncovered portion of casing 10. The end of handle 40 that extends through the hole in saddle bag 15 includes a latch mechanism activated by a pushbutton 43 for selectively connecting that end of handle 40 into a portion of casing 10 underlying saddle bag 15. A ring 41 is provided about the end of handle 40 for aesthetic reasons. Thus, saddle bag 15 may be selectively removed and washed or otherwise replaced by pressing button 43 on handle 40 and pulling that end of handle 40 from an aperture formed in casing 10 and then pulling at saddle bag 15 to unfasten it from casing 10.

Lens ring 46 may include a pair of apertures 75 to which a strap (not shown for this embodiment) may be connected. The opposite end of such a strap would connect to the rear of the lantern so as to enable the lantern to be slung over a person's shoulder in a manner similar to that shown in FIG. 10B.

As shown in FIGS. 1-7, the lantern includes a stand 250 that is pivotally attached to a lower portion of lantern casing 10. Stand 250 provides a stable surface that enables the lantern to be set on a work surface in an upright and stable position regardless of the relative weights of articles that may be stowed in the pockets on either side of the fabric housing 15.

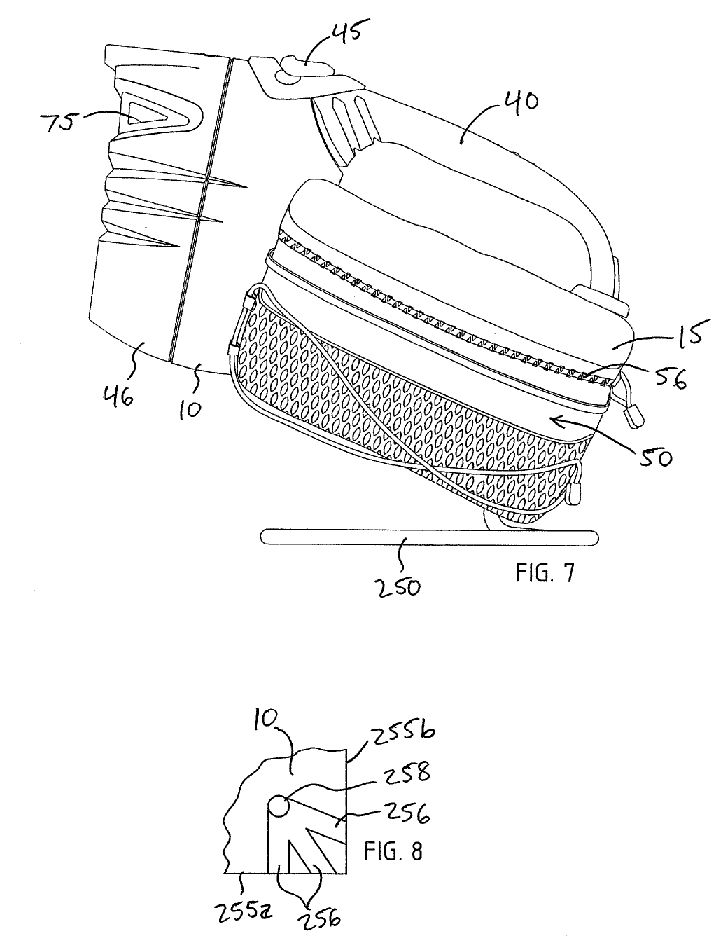

Stand 250 may include a wire frame as shown in FIGS. 1-7 or any other form of support. The wire frame stand shown in the drawings is essentially a rigid loop having two ends that are bent and extend into opposing holes 258 (FIG. 8) on either side of the lantern casing 10. As shown in FIG. 8, hole 258, in which one of the ends of stand 250 is inserted, is spaced upward from a bottom surface 255a of lantern casing 10 and inward from a rear surface 255b of casing 10. Lantern casing 10 includes a plurality of grooves 256 extending from hole 258 to one of surfaces 255a or 255b in order to releasingly engage one of the two legs of stand 250. In FIG. 8, three such grooves 256 are shown, each of which extends at a different angle from hole 258. In this manner, the lantern may be inclined from the surface upon which it rests at various angles and remain in such an inclined position until such time that a user pivots stand 250 relative to lantern casing 10 (see FIGS. 2 and 7).

FIGS. 9A, 9B, and 9C illustrate a lantern constructed in accordance with a second embodiment of the present invention. This lantern includes an interior frame 10 having a forward portion 12, a rear portion 13, and a middle portion 14 extending between forward and rearward portions 12 and 13. The lantern further includes a fabric saddlebag 15 that extends around middle portion 14 of interior frame 10. Saddlebag 15 may be secured to interior frame 10 by means of any conventional fastener such as snaps or the hook-and-loop type fastener 16 that is illustrated in FIG. 9C. Saddlebag 15 is preferably releasably attached to interior frame 10 by means of fastener 16 to allow access to a battery compartment 18 provided in middle portion 14 of interior frame 10. As shown in FIG. 9C, battery compartment 18 may be configured to receive a plurality of batteries 20.

A switch mechanism 22 is preferably mounted to an upper portion of the front 12 of interior frame 10. By making interior frame 10 of a rigid material, such as plastic or metal, and locating switch mechanism 22 on rigid interior frame 10, the user may press firmly on the switch to achieve reliable operation.

The lantern of the first embodiment further includes a pair of protruding ridges 24 spaced apart and in parallel, and extending vertically along the rear 13 of interior frame 10. Ridges 24 each include a first through-hole 26 through which a first pin 28 may be inserted. Pin 28 may be a cotter pin or screw. First through-holes 26 and first pin 28 are provided to enable a mesh pouch 34 to be attached to the rear of the lantern. Mesh pouch 34 includes a rigid tongue 32 that is dimensioned so as to fit between protruding ridges 24. Tongue 32 includes a through-hole 30 that aligns with first through-holes 26 and ridges 24 such that pin 28 may be passed therethrough to secure mesh pouch 34 on the lantern.

Mesh pouch 34 preferably includes a closure mechanism such as drawstring 36. Mesh pouch 34 may be used to store various items such as extra batteries, a spare light bulb, a rain poncho, etc.

The pair of ridges 24 each further include a second through-hole 38 through which a second pin or screw 39 may extend so as to secure one end of a handle 40. The other end of handle 40 may be secured to forward portion 12 of interior frame 10.

The lantern may further include a reflector 42 in which a light bulb 44 is mounted. Additionally, the lantern may include a bezel 46 having a switch pushbutton cover 45 for allowing the user to activate switch mechanism 22 housed inside the space between bezel 46 and forward portion 12 of interior frame 10. Additionally, the lantern preferably includes a lens 48.

By forming the lantern housing utilizing both a rigid interior frame 10 and a saddlebag 15 made of fabric, a desired structural rigidity for the lantern is provided for handling the lantern and incorporating the batteries and other functional features used to generate light, while also providing functional features resulting from the use of the fabric.

As shown in FIGS. 9A, 9B, and 9C, saddlebag 15 may include a side pocket 50 that may be opened and secured in a closed position by means of a latch mechanism 52. Additionally, saddlebag 15 may include an inner compartment 54 that is accessed by means of one or more closure mechanisms, such as zippers 56. As shown in FIG. 9B, inner compartment 54 may include a plurality of inner pockets 58 for securing various items carried by the user. Although not illustrated in the drawings, saddlebag 15 may include similar or different pockets and compartments on the other side.

The lantern of the second embodiment may further include a handle clasp 60 that secures the strap of handle 40 in a folded condition. This allows the handle to be contained in a easy-to-grasp condition and provide some rigidity for holding the lantern. Clasp 60 may be removed to unfold the strap of handle 40 whereby the lantern strap may be slung over the user's shoulder and/or neck or otherwise used to hang the lantern from some other article.

As will be apparent from reviewing all the embodiments of the invention, the use of fabric as a portion of the lantern or flashlight not only creates added functionality, but also allows for the implementation of unique appearances that could not previously be obtained using the materials conventionally used for such devices.

A lantern constructed in accordance with a third embodiment is shown in FIGS. 10A and 10B. This lantern is similar in many respects to that of the first embodiment with the exception that it incorporates a zippered compartment 70 attached to the rear of the lantern, it includes a rigid handle 72 attached to the interior frame (not shown), it includes an outer mesh 74 in lieu of a side pocket, and its bezel 46 includes a pair of holes 75. As shown in FIG. 10B, a strap 76 may be contained in rear compartment 70 and attached within compartment 70 to the interior frame. The other end of strap 76 splits into two segments with a spring clip 78 on each end for attaching to a respective hole 75 in bezel 46. In this manner, a user may quickly deploy and secure strap 76 so that the lantern may be slung over a shoulder or suspended by strap 76. This embodiment has the advantage that handle 72 remains intact simultaneously with the deployment of strap handle 76.

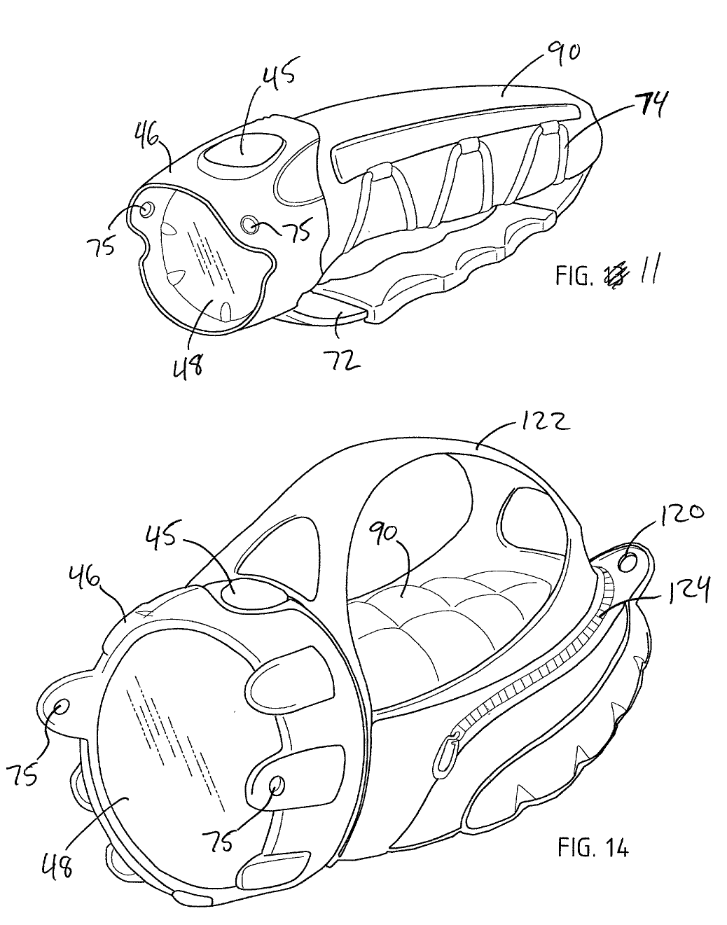

FIG. 11 shows a flashlight constructed in accordance with a fourth embodiment of the present invention. As will be apparent from a comparison of the flashlight in FIG. 11 with the lantern in FIG. 10A, the use of a fabric housing 90 enables a designer to create a similarity in appearance between these two different types of lighting devices that may otherwise be unobtainable. Specifically, fabric lacing 74 may similarly be employed in the flashlight of FIG. 11, which, along with the color and material selection for fabric housing 90, can create similar consumer impressions despite the differences in shape and configuration. The flashlight in FIG. 11 may further be configured to have a similarly shaped bezel 46 having a pair of holes 75. Additionally, the flashlight may be configured with a handle 72. The flashlight fabric housing 90 may include a zipper or other fastener to reveal an interior compartment to allow replacement of the batteries.

FIG. 12 shows a flashlight constructed in accordance with a fifth embodiment of the present invention. This flashlight, like the flashlight shown in FIG. 11, incorporates a fabric housing 90 and a rigid bezel 46 having a switch cover 45 mounted thereon. The flashlight in FIG. 12 differs from that in FIG. 11 in that it incorporates a side pocket 50 that opens to the rear of the flashlight. Side pocket 50 may be secured in a closed position by a latch 52 or other mechanism.

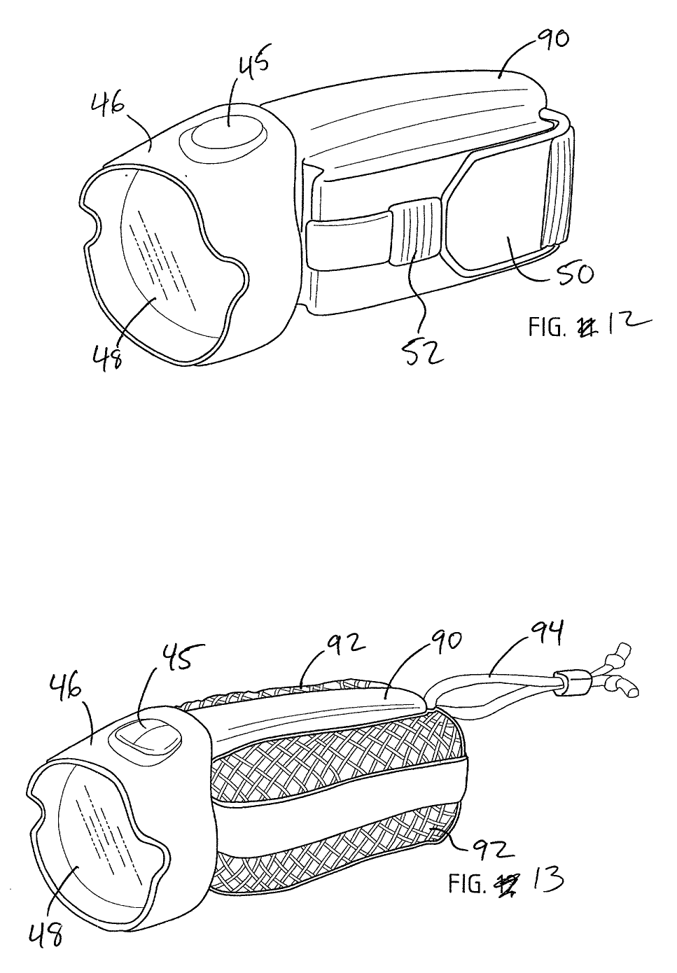

FIG. 13 shows a flashlight constructed in accordance with a sixth embodiment of the present invention. This flashlight also includes a fabric housing 90, a rigid bezel 46, and a switch cover 45 mounted on bezel 46. In lieu of the side pocket 50 of the flashlight shown in FIG. 12, this flashlight incorporates a pair of mesh side pockets 92 that open to the rear of the flashlight and are closed by means of a drawstring 94.

FIG. 14 shows a lantern constructed in accordance with a seventh embodiment of the present invention. This lantern includes a bezel 46 with a switch 45 mounted on bezel 46, and a pair of holes 75 in the bezel along with a hole 120 at the rear of the flashlight housing for attachment of a strap, spring clip, or hanging ring. This lantern includes a uniquely shaped handle 122 that extends upward from both the front, back, and sides of a fabric housing 90. This lantern may also include a zippered compartment 124 that enables the whole upper portion of the housing to be pulled back from the lower portion to reveal the battery compartment and space for additional items.

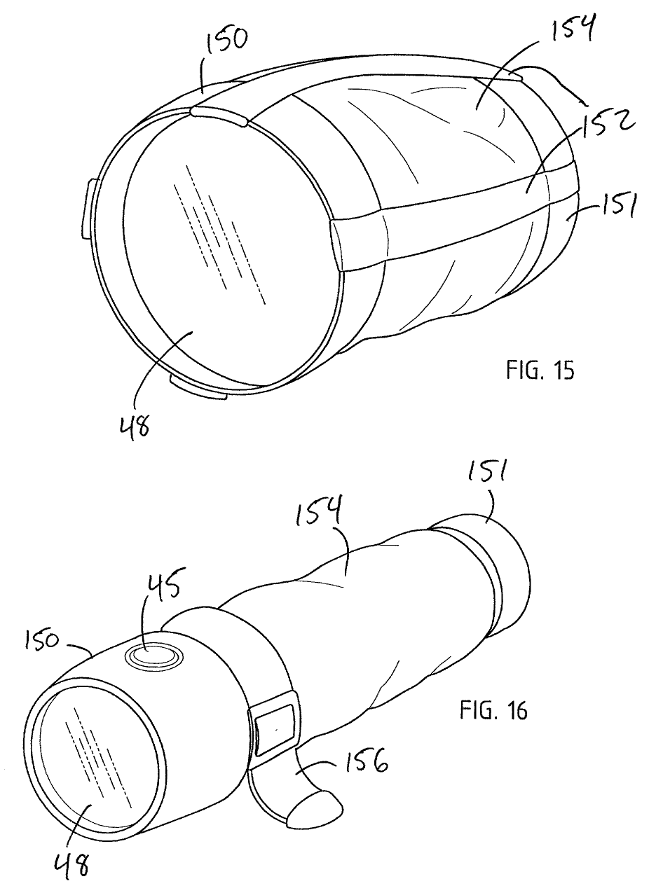

FIG. 15 shows a lantern constructed in accordance with an eighth embodiment of the present invention. This lantern includes a textured bezel and rear portion that are held in spaced relation by the interior components and one or more nylon straps 152. A thin nylon cover 154 may be used to cover the interior components between front bezel 150 and rear 151 of the lantern.

FIG. 16 shows a flashlight constructed in accordance with a ninth embodiment of the present invention. As will be apparent to those skilled in the art, the flashlight in FIG. 16 has a similar appearance to the lantern in FIG. 15. The flashlight includes a textured bezel 150 having a pushbutton switch 45 mounted on bezel 150. The flashlight further includes a rigid end portion 151 and a nylon cover. The flashlight additionally includes an adjustable nylon strap 156 that wraps around cover 154.

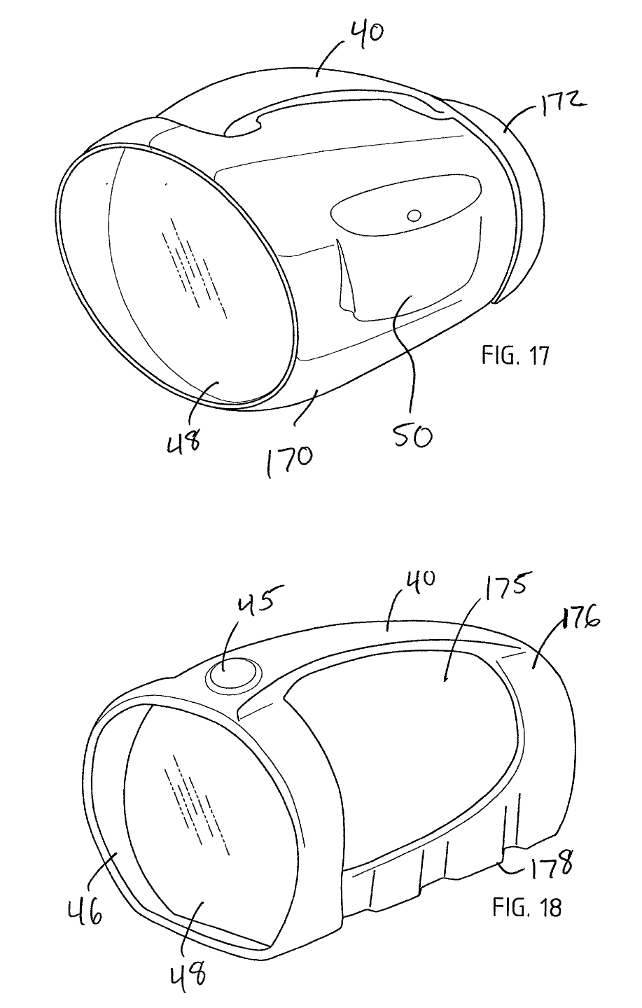

FIG. 17 shows a lantern constructed in accordance with a tenth embodiment of the present invention. This flashlight includes a cordura shell 170 that additionally wraps around a portion of the interior frame so as to serve as the bezel for the lantern. This lantern further includes a side cargo pocket 50 having an upper flap that snaps over the opening in the pocket. A nylon strap handle 40 may be attached to the top of the flashlight housing and a rubber end cap 172 may be applied to the rear of the lantern.

FIG. 18 shows a lantern constructed in accordance with an eleventh embodiment of the present invention. This lantern includes a bezel 46, a rear end cap 176, a rigid handle 40 extending between bezel 46 and rear end portion 176, and a flat bottom portion 178 extending between bezel 46 and end 176 on an opposite side from handle 40. A pushbutton switch 45 is positioned on handle 40 and a fabric 175 extends around the middle portion of the lantern.

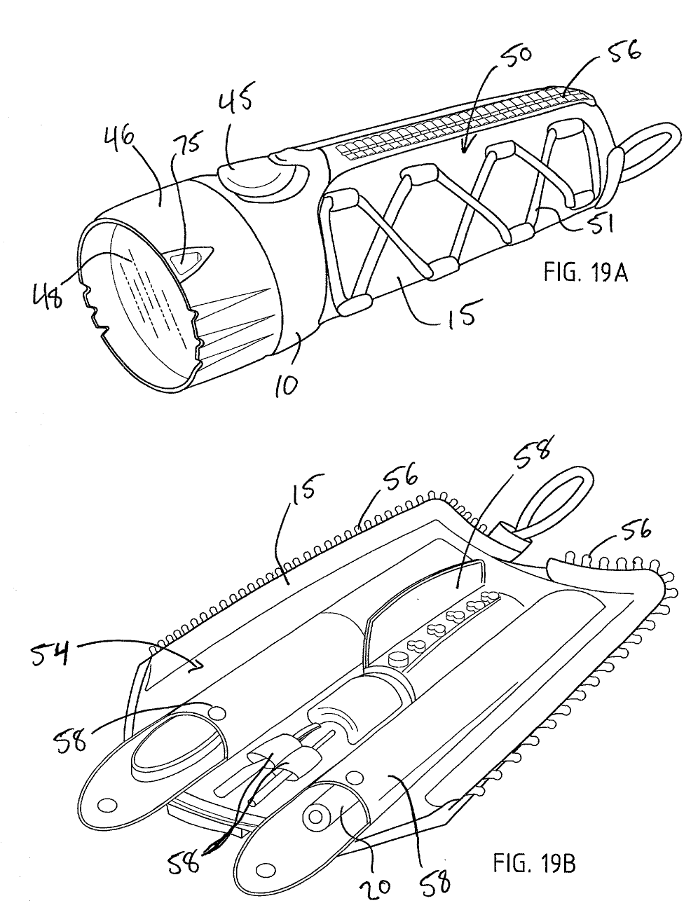

FIGS. 19A and 19B show a flashlight constructed in accordance with a twelfth embodiment of the present invention. The flashlight includes a rigid frame 10 having an unexposed portion on which a pushbutton switch cover 45 is accessible. The flashlight further includes a lens ring 46, which is not covered by fabric and which supports a lens 48 as well as the reflector and light source (not shown). A fabric portion 15 wraps around and is fastened to frame 10. On the outside of fabric portion 15 is a shock cord 51 that is configured to define an outer storage compartment 50. A zipper 56 is provided to allow access to an inner storage compartment 54 (see FIG. 19B), which includes a plurality of storage pockets 58 for storing items such as a pocket knife, spare batteries 20, tweezers, toothpicks, and other personal items. As shown in FIG. 19B, fabric portion 15 may be configured to be selectively removed from frame 10 to allow easy access to inner storage compartment 54.

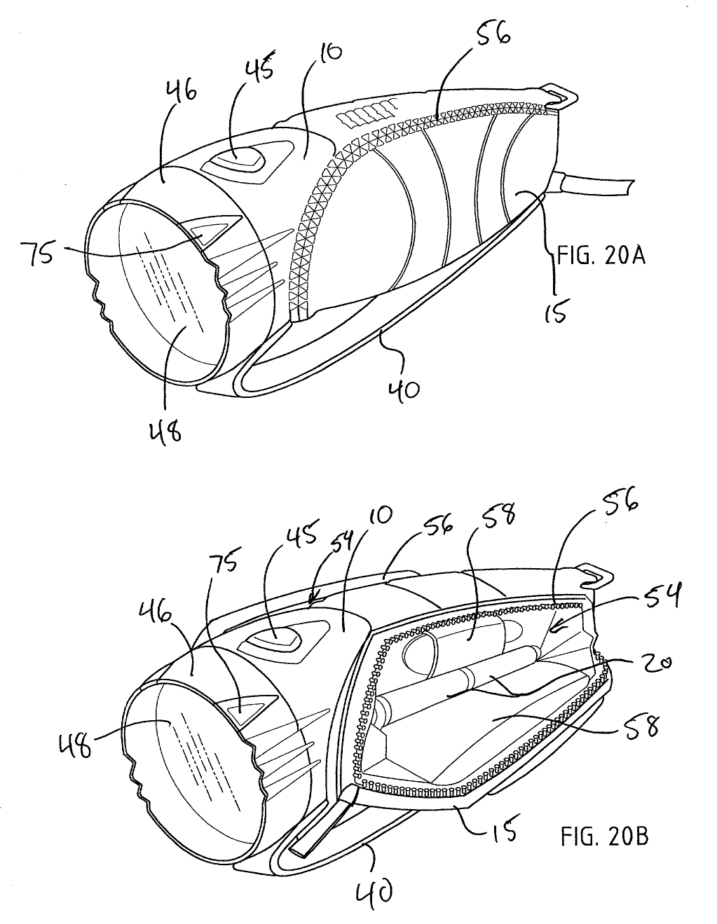

FIGS. 20A and 20B show a flashlight constructed in accordance with a thirteenth embodiment of the present invention. This flashlight also includes a rigid frame 10 on which a pushbutton switch cover 45 is mounted. A lens ring 46 is also provided to support a lens 48 and other components. Fabric portion 15 includes a pair of inner storage compartments 54 that are closed by means of respective zippers 56. Storage compartments 54 may include inner storage pockets 58 in the manners previously discussed. This flashlight may include a handle or strap 40 along its bottom to facilitate carrying the light.

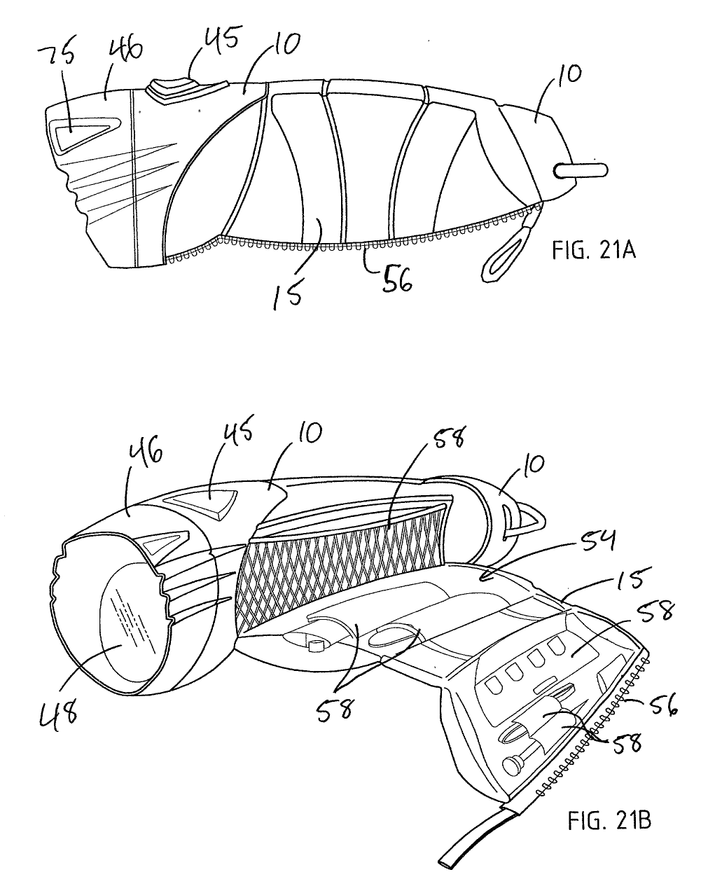

FIGS. 21A and 21B illustrate a flashlight constructed in accordance with a fourteenth embodiment of the present invention. This flashlight also includes a rigid casing having an uncovered portion on which a pushbutton switch cover 45 may be provided. Attached to this portion of the casing/frame 10 is a lens ring 46 for supporting a lens 48 and other components. Frame 10 extends through the length of the flashlight and has another uncovered portion at the rear of the flashlight. A fabric portion 15 is fastened to frame 10 along a bottom edge and wraps completely around the flashlight body and is joined together along the bottom of the flashlight by a zipper 56 or other suitable closing mechanism. A fabric portion 15 thus provides an inner storage compartment 54 having a plurality of storage pockets 58.

The above description is considered that of the preferred embodiments only. Modifications of the invention will occur to those skilled in the art and to those who make or use the invention. Therefore, it is understood that the embodiments shown in the drawings and described above are merely for illustrative purposes and not intended to limit the scope of the invention, which is defined by the following claims as interpreted according to the principles of patent law, including the doctrine of equivalents.

What is claimed is:

1. A portable lighting device comprising:
a rigid frame at least partially defining a battery compartment having battery contact terminals;
a reflector mounted to said frame;
a light source mounted to said frame forward of said reflector, said light source being selectively electrically coupled to said battery contact terminals via a switching mechanism; and
a fabric portion fastened to said frame and made of a fabric material, said fabric portion including a storage compartment that is accessible from the exterior of the lighting device.

2. The portable lighting device of claim 1, wherein said fabric portion is releasably fastened to said frame.

3. The portable lighting device of claim 1, wherein said fabric portion is fastened to said frame by a fastening mechanism.

4. The portable lighting device of claim 3, wherein said fastening mechanism has a first part fixed to said frame and a second part fixed to said fabric portion.

5. The portable lighting device of claim 4, wherein said fastening mechanism is a hook-and-loop type fastener.

6. The portable lighting device of claim 1, wherein said fabric portion is adhesively fastened to said frame.

7. The portable lighting device of claim 1, wherein said fabric portion is fastened to said frame by a thermal bond.

8. The portable lighting device of claim 1, wherein said fabric portion is fastened to said frame by a strap.

9. The portable lighting device of claim 8, wherein said strap is secured to said frame and is releasably attached to said fabric portion.

10. The portable lighting device of claim 8, wherein said strap is secured to said fabric portion and is releasably attached to said frame.

11. The portable lighting device of claim 1, wherein said switch mechanism is a pushbutton switch.

12. The portable lighting device of claim 1, wherein said switch mechanism is a slide switch.

13. The portable lighting device of claim 1, wherein said switch mechanism is a rotary switch.

14. The portable lighting device of claim 1 and further comprising a lens ring rotatably attached to said frame.

15. The portable lighting device of claim 14, wherein said switch mechanism is integrated into said lens ring so as to be activated and deactivated through rotation of said lens ring.

16. The portable lighting device of claim 1, wherein said fabric portion is configured as a saddle bag that wraps partially around said frame.

17. The portable lighting device of claim 1 and further comprising a handle attached to said frame.

18. The portable lighting device of claim 1 and further comprising a strap attached to said frame.

19. The portable lighting device of claim 18, wherein said strap has an adjustable length.

20. The portable lighting device of claim 18, wherein the fabric portion covers a portion of said frame leaving portions of the frame uncovered and exposed to an exterior of the lighting device, wherein said strap is coupled to uncovered portions of said frame.

21. The portable lighting device of claim 20, wherein said strap is coupled at one end to a first uncovered portion of said frame proximate the rear of the lighting device and coupled to a second uncovered portion of said frame proximate said bezel.

22. The portable lighting device of claim 21, wherein said fabric portion extends over and covers a portion of said frame between said first and second uncovered portions.

23. The portable lighting device of claim 1 and further comprising a fabric pouch secured to said frame.

24. The portable lighting device of claim 1, wherein said frame includes a recess for receiving the switching mechanism.

25. The portable lighting device of claim 24, wherein said frame further includes one of a bezel and lens ring.

26. The portable lighting device of claim 25, wherein said fabric portion is fastened to and partially covers said frame, wherein an uncovered portion of said frame includes at least one of said bezel, said lens ring, and said recess for receiving the switching mechanism.

27. The portable lighting device of claim 1, wherein said frame partially defines said battery compartment and said fabric portion defines a remaining portion of said battery compartment.

28. The portable lighting device of claim 1, wherein said fabric portion covers a portion of said frame leaving an uncovered portion that exposes the switching mechanism.

29. The portable lighting device of claim 1, wherein said fabric portion includes a plurality of storage compartments that are accessible from the exterior of the lighting device.

30. The portable lighting device of claim 29 and further comprising a plurality of closing mechanisms for closing each of said storage compartments.

31. The portable lighting device of claim 30, wherein said closing mechanisms including any one or combination of a zipper, a hook-and-loop type fastener, a drawstring, and a clip.

32. The portable lighting device of claim 31, wherein a closing mechanism for at least one of said storage compartments is different from a closing mechanism for another one of said storage compartments.

33. The portable lighting device of claim 1 and further comprising a closing mechanism for closing said storage compartment.

34. The portable lighting device of claim 33, wherein said closing mechanism includes any one of a zipper, a hook-and-loop type fastener, a drawstring, and a clip.

35. The portable lighting device of claim 1, wherein said fabric portion is made of any one or combination of nylon, canvas, leather, Kevlar®, Tyvek®, and Gore-Tex®.

36. The portable lighting device of claim 1, wherein at least a portion of said fabric portion is made of a fabric mesh material.

37. The portable lighting device of claim 1, wherein said fabric portion is made of at least two different materials.

38. The portable lighting device of claim 37, wherein each of said different materials is exposed on an exterior of the lighting device.

39. The portable lighting device of claim 1, wherein said fabric portion includes a plurality of storage pockets within said storage compartment.

40. A portable lighting device comprising:
a rigid frame at least partially defining a battery compartment having battery contact terminals;
a light source mounted to said frame, said light source being selectively electrically coupled to said battery contact terminals via a switching mechanism; and
a fabric portion covering a portion of said frame and made of at least two different fabric materials.

41. The portable lighting device of claim 40, wherein said fabric portion is fastened to said frame.

42. The portable lighting device of claim 40, wherein said fabric portion is fastened to said frame by a fastening mechanism.

43. The portable lighting device of claim 40 and further comprising a lens ring attached to said frame.

44. The portable lighting device of claim 40, wherein said fabric portion is configured as a saddle bag that wraps partially around said frame.

45. The portable lighting device of claim 40 and further comprising a handle attached to said frame.

46. The portable lighting device of claim 40 and further comprising a strap attached to said frame.

47. The portable lighting device of claim 46, wherein the fabric portion covers a portion of said frame leaving portions of the frame uncovered and exposed to an exterior of the lighting device, wherein said strap is coupled to uncovered portions of said frame.

48. The portable lighting device of claim 40 and further comprising a fabric pouch secured to said frame.

49. The portable lighting device of claim 40, wherein said frame includes a recess for receiving the switching mechanism.

50. The portable lighting device of claim 40, wherein said fabric portion includes a plurality of storage compartments that are accessible from the exterior of the lighting device.

51. The portable lighting device of claim 50, wherein said fabric portion includes a plurality of storage pockets within at least one of said storage compartments.

52. The portable lighting device of claim 40, wherein said fabric portion is made of any combination of nylon, canvas, leather, Kevlar®, Tyvek®, and Gore-Tex®.

53. The portable lighting device of claim 40, wherein at least a portion of said fabric portion is made of a fabric mesh material.

54. The portable lighting device of claim 40, wherein each of said different materials being exposed on an exterior of the lighting device.

55. A portable lighting device comprising:
a rigid casing including a recess for receiving a switching mechanism and one of a bezel and lens ring;
a light source supported on said casing and selectively activated in response to actuation of said switching mechanism; and
a fabric component fastened to and partially covering said casing, wherein an uncovered portion of said casing includes at least one of said bezel, said lens ring, and said recess for receiving said switching mechanism.

56. The portable lighting device of claim 55, wherein said rigid casing partially defines a battery compartment and said fabric component defines a remaining portion of said battery compartment.

57. The portable light device of claim 55, wherein said uncovered portion of said casing includes said recess and said switching mechanism.

58. The portable light device of claim 55, wherein said uncovered portion of said casing includes said bezel.

59. The portable light device of claim 55, wherein said recess for receiving said switching mechanism is positioned on said bezel and said uncovered portion of said casing includes said bezel.

60. The portable lighting device of claim 55, wherein said fabric component is releasably fastened to said casing.

61. The portable lighting device of claim 55, wherein said fabric component is fastened directly to said casing by a fastening mechanism.

62. The portable lighting device of claim 61, wherein said fastening mechanism has a first part fixed to said casing and a second part fixed to said fabric component.

63. The portable lighting device of claim 55, wherein said fabric component is configured as a saddle bag that wraps partially around said casing.

64. The portable lighting device of claim 55 and further comprising a handle attached to said casing.

65. The portable lighting device of claim 55 and further comprising a strap attached to said casing.

66. The portable lighting device of claim 65, wherein the fabric component covers a portion of said casing leaving portions of said casing uncovered and exposed to an exterior of the lighting device, wherein said strap is coupled to uncovered portions of said casing.

67. The portable lighting device of claim 66, wherein said strap is coupled at one end to a first uncovered portion of said casing proximate the rear of the lighting device and coupled to a second uncovered portion of said casing proximate said bezel.

68. The portable lighting device of claim 67, wherein said fabric component extends over and covers a portion of said casing between said first and second uncovered portions.

69. The portable lighting device of claim 55 and further comprising a fabric pouch secured to said casing.

70. The portable lighting device of claim 55, wherein said fabric component includes a plurality of storage compartments that are accessible from the exterior of the lighting device.

71. The portable lighting device of claim 70, wherein said fabric component includes a plurality of storage pockets within at least one of said storage compartments.

72. The portable lighting device of claim 55, wherein said fabric component is made of any one or combination of nylon, canvas, leather, Kevlar®, Tyvek®, and Gore-Tex®.

73. The portable lighting device of claim 55, wherein said fabric component is made of at least two different fabric materials.

74. A portable lighting device comprising:
a rigid frame at least partially defining a battery compartment having battery contact terminals;
a light source mounted to said frame, said light source being selectively electrically coupled to said battery contact terminals via a switching mechanism; and
a fabric portion covering a portion of said frame and including at least one storage compartment that is accessible from the exterior of the lighting device, said fabric portion including a plurality of storage pockets within said storage compartment.

75. The portable lighting device of claim 74, wherein said fabric portion is fastened to said frame.

76. The portable lighting device of claim 74, wherein said fabric portion is fastened to said frame by a fastening mechanism.

77. The portable lighting device of claim 74, wherein said fabric portion is configured as a saddle bag that wraps partially around said frame.

78. The portable lighting device of claim 74 and further comprising a handle attached to said frame.

79. The portable lighting device of claim 74 and further comprising a strap attached to said frame.

80. The portable lighting device of claim 74 and further comprising a fabric pouch secured to said frame.

81. The portable lighting device of claim 74, wherein said frame includes a recess for receiving the switching mechanism.

82. The portable lighting device of claim 74, wherein said fabric portion includes a plurality of storage compartments that are accessible from the exterior of the lighting device.

83. The portable lighting device of claim 82 and further comprising a plurality of closing mechanisms for closing each of said storage compartments.

84. The portable lighting device of claim 83, wherein said closing mechanisms including any one or combination of a zipper, a hook-and-loop type fastener, a drawstring, and a clip.

85. The portable lighting device of claim 84, wherein a closing mechanism for at least one of said storage compartments is a different type from a closing mechanism for another one of said storage compartments.

86. The portable lighting device of claim 74 and further comprising a closing mechanism for closing said storage compartment.

87. The portable lighting device of claim 86, wherein said closing mechanism includes any one of a zipper, a hook-and-loop type fastener, a drawstring, and a clip.

88. The portable lighting device of claim 74, wherein said fabric portion is made of any one or combination of nylon, canvas, leather, Kevlar®, Tyvek®, and Gore-Tex®.

89. The portable lighting device of claim 74, wherein at least a portion of said fabric portion is made of a fabric mesh material.

90. The portable lighting device of claim 74, wherein said fabric portion is made of at least two different materials.

91. A lantern comprising:
a rigid casing having a rearward end and a bezel provided at a forward end, said casing defining a battery compartment having battery contact terminals, said bezel defining a light emitting opening;
a lens disposed across the light emitting opening of said bezel;
a switching mechanism mounted on said casing and electrically coupled to at least one of said battery contact terminals;
a reflector mounted to said casing within said bezel;
a light source supported by said casing and electrically coupled to said switching mechanism, said light source disposed slightly forward of a rearwardmost portion of said reflector such that light emitted from said light source is reflected from said reflector through said lens;
a fabric saddle bag covering a portion of said casing leaving portions of the casing uncovered and exposed to an exterior of the lantern, such uncovered portions including said bezel and said switching mechanism, said fabric saddle bag including a plurality of storage compartments, a plurality of closing mechanisms for closing said storage compartments that are accessible from the exterior of the lantern, and a plurality of pockets within at least one of said storage compartments, wherein said fabric saddle bag is made of at least two different fabric materials; and
a fastening mechanism for fastening said fabric saddle directly to said casing, said fastening mechanism including a first part fixed to said casing and a second part fixed to said fabric saddle.

92. The lantern of claim 91, wherein said fabric saddle is releasably fastened to said casing.

93. The lantern of claim 91, wherein said fastening mechanism is a hook-and-loop type fastener.

94. The lantern of claim 91, wherein said switch mechanism is a pushbutton switch.

95. The lantern of claim 91, wherein said switch mechanism is a slide switch.

96. The lantern of claim 91, wherein said switch mechanism is a rotary switch.

97. The lantern of claim 91 and further comprising a handle attached to said casing.

98. The lantern of claim 97, wherein said handle is coupled to a first uncovered portion at the rearward end of said casing and to a second uncovered portion of said casing proximate said bezel.

99. The lantern of claim 98, wherein said fabric portion extends over and covers a portion of said casing between said first and second uncovered portions.

100. The lantern of claim 91 and further comprising a fabric pouch secured to said casing.

101. The lantern of claim 91, wherein said closing mechanisms include any one or combination of a zipper, a hook-and-loop type fastener, a drawstring, and a clip.

102. The lantern of claim 91, wherein a closing mechanism for at least one of said storage compartments is a different type from a closing mechanism for another one of said storage compartments.

103. The lantern of claim 91, wherein said fabric saddle is made of any one or combination of nylon, canvas, leather, Kevlar®, Tyvek®, and Gore-Tex®.

104. The lantern of claim 91, wherein at least a portion of said fabric portion is made of a fabric mesh material.

105. The lantern of claim 91 and further including a stand pivotally mounted to said casing.

106. A portable lighting device comprising:
a casing having a rearward end and a forward end;
a flexible strap having first and second ends, said first end fastened at the rearward end of said casing, said strap having a fastener provided at said second end;
a lens ring provided at the forward end of said casing and including at least one aperture configured to receive said fastener; and
a light source positioned at the forward end of said casing.

107. The portable lighting device of claim 106 further comprising a fabric component fastened to said casing.

108. The portable lighting device of claim 107, wherein the fabric component covers a portion of said casing leaving portions of said casing uncovered and exposed to an exterior of the lighting device, wherein said strap is coupled to uncovered portions of said casing.

109. The portable lighting device of claim 108, wherein said strap is coupled at one end to a first uncovered portion of said casing proximate the rear of the lighting device and coupled to a second uncovered portion of said casing proximate said bezel.

110. The portable lighting device of claim 109, wherein said fabric component extends over and covers a portion of said casing between said first and second uncovered portions.

111. The portable lighting device of claim 106 and further comprising a fabric pouch secured to the rearward end of said casing for storing said strap.

112. The portable lighting device of claim 106, wherein said fabric component is configured as a saddle bag that wraps partially around said casing.

113. The portable lighting device of claim 106, wherein said strap has an adjustable length.

114. The portable lighting device of claim 113, wherein said strap is adjustable to a first length suitable for use as a handle and a second length suitable for use as a shoulder strap.
